(19) United States
(12) Patent Application Publication
(10) Pub. No.: US 2001/0016914 A1
(43) Pub. Date: Aug. 23, 2001

(54) IP virtual private network constructing method and IP virtual private network

(75) Inventor: Osamu Tabata, Tokyo (JP)

Correspondence Address: FOLEY & LARDNER, Washington Harbour, 3000 K Street, N.W., Suite 500, P.O. Box 25696, Washington, DC, 20007-8696, US

(73) Assignee: NEC CORPORATION

(21) Appl. No.: 09/778,934

(22) Filed: Feb. 8, 2001

(30) Foreign Application Priority Data
Feb. 21, 2000 (JP) 2000-042963

(51) Int. Cl. H04L 9/00

(52) U.S. Cl. 713/201

(57) ABSTRACT

An edge node which receives an IP packet transmitted from a user adds thereto information including an external IP header and an IP virtual private network identifier for identifying each of a plurality of IP-VPNs present within a network to transfer the packet to a backbone node in the network. The edge node is assigned a plurality of different IP addresses in accordance with quality (required bandwidth) of an in-network packet.

### BACKGROUND OF THE INVENTION

1. Field of the Invention

The present invention relates to an IP Virtual Private Network (hereinafter abbreviated as “IP-VPN”) constructed on a public network such as the Internet and comprising virtual dedicated lines for communication only between particular users.

2. Description of the Related Art

When an IP-VPN is constructed in companies or other organizations (hereinafter referred to as “end users”), end users conventionally install for themselves equipment supporting an IP security scheme which is one of schemes for constructing the IP-VPN and make a contract with a carrier/ISP providing Internet services or the like for utilizing the Internet to realize the IP-VPN.

However, the aforementioned IP-VPN for which end users operate the IP security equipment on their own to construct the network requires cost for securing operators, purchase of complicated equipment, or maintenance of equipment. Therefore, it is expected that carriers/ISPs provide low-cost IP-VPN services.

Since the IP-VPN mainly transfers IP (Internet Protocol) data, IP-VPN services can be provided on the existing Internet, and it is desirable to use the backbone of the Internet also in the IP-VPN for lower cost thereof. In other words, a configuration compatible with the existing Internet is a realistic solution for realizing the IP-VPN services.

The current Internet transfers packets in a connectionless manner, and it is generally difficult to ensure a communication bandwidth available to each end user. In recent years, however, the IP-VPN is expected as a network for transferring important information, and quality control is also important for securing a required bandwidth for each end user.

In addition, it is contemplated that a plurality of carriers/ISPs are interconnected to allow provision of IP-VPN services with a wider area than that of a single carrier/ISP for end users who expect such IP-VPN services with a wider area. In this case, however, a problem occurs that different protocols in respective networks for IP-VPNs make their interconnection difficult.

In recent years, as a predominant scheme for realizing the IP-VPN, MPLS (MultiProtocol Label Switching) is considered in IETF (Internet Engineering Task Force) and the like. Thus, easy interconnection with networks of the MPLS scheme is a key factor for the carriers/ISPs to provide competitive IP-VPN services.

### SUMMARY OF THE INVENTION

The present invention has been made to solve the aforementioned problems presented by the prior art, and it is an object thereof to provide an IP-VPN which can secure a required bandwidth for each end user and can be easily interconnect to a network of the MPLS scheme.

To achieve the aforementioned object, the present invention provides a method of constructing an IP virtual private network comprising a virtual dedicated line for performing communication between particular users on a backbone network, comprising the steps of:

creating an in-network packet by adding, to a user packet including IP data transmitted from a user, in-network additional information comprising in-network header information in the same form as an IPv4 format including information identifying a user to whom the user packet is to be transmitted and representing precedence of the user packet and IP-VPN identifying information in the same form as a shim header of an MPLS scheme including a VPN-ID serving as an identifier for identifying each of a plurality of virtual private networks present within the backbone network, and transmitting the created in-network packet to the backbone network; and

deleting the in-network additional information from the in-network packet transmitted from the backbone network, and transferring the packet to a predetermined user as the user packet.

In this case, an edge node possessed by the backbone network and connected to the user may be assigned a plurality of different IP addresses in accordance with the precedence for securing a communication bandwidth required by the user.

An IP address for transferring the in-network packet to the edge node connected to the user to whom the packet is to be transmitted on a route in accordance with the precedence may be inserted in the in-network header information.

On the other hand, according to the present invention, an IP virtual private network comprising a virtual dedicated line for performing communication between particular users constructed on a backbone network is provided, the IP virtual private network comprising:

a plurality of edge nodes for creating an in-network packet by adding, to a user packet including IP data transmitted from the user, in-network additional information comprising in-network header information in the same form as an IPv4 format including information identifying a user to whom the user packet is to be transmitted and representing precedence of the user packet and IP-VPN identifying information in the same form as a shim header of an MPLS scheme including a VPN-ID serving as an identifier for identifying each of a plurality of virtual private networks present within the backbone network, and

a plurality of backbone nodes for transferring the in-network packet to the edge node connected to the user to whom the packet is to be transmitted.

In this case, the edge node may delete the in-network additional information from the in-network packet transmitted from the backbone network and may transfer the packet to a predetermined user as the user packet.

The edge node may be supplied with transfer control information for determining a transfer target of the in-network packet, bandwidth information in accordance with the precedence, and contents of the in-network additional information.

The IP virtual private network may further comprise a policy server for providing the backbone node with backbone transfer control information for indicating a transfer target of the in-network packet.

In addition, the edge node may limit a bandwidth of an in-network packet to be output in accordance with the bandwidth information.

The edge node may be assigned a plurality of different IP addresses in accordance with the precedence for securing a communication bandwidth required by the user.

The edge node connected to the user from which the packet is transmitted may insert in the in-network header information an IP address for transferring the in-network packet to the edge node connected to the user to whom the packet is to be transmitted on a route in accordance with the precedence.

In the aforementioned IP virtual private network, a user packet from an end user is transmitted to the backbone network after in-network additional information is added thereto, and an edge node connecting to a transfer target user is assigned a plurality of different IP addresses in accordance with precedence. Thus, a stable transfer route for securing a required bandwidth is determined.

In addition, the edge node limits the output bandwidth of an in-network packet according to predetermined quality control information to perform control such that an in-network packet exceeding the bandwidth based on the contract with a user is not transmitted to the backbone network.

### BRIEF DESCRIPTION OF THE DRAWINGS

FIG. 1 is a block diagram showing a configuration of a network for realizing an IP-VPN of the present invention;

FIG. 2 is a block diagram showing an exemplary configuration of an in-network packet transferred and received in a backbone network shown in FIG. 1;

FIG. 3 is a block diagram showing an exemplary configuration of in-network header information shown in FIG. 2;

FIG. 4 is a block diagram showing an exemplary configuration of IP-VPN identifying information shown in FIG. 2;

FIG. 5 is a block diagram showing an exemplary configuration of an edge node shown in FIG. 1;

FIG. 6 is a block diagram showing an exemplary configuration of a backbone node shown in FIG. 1;

FIG. 7 is a table showing an example of ingress transfer control information used in the edge node shown in FIG. 5;

FIG. 8 is a table showing an example of egress transfer control information used in the edge node shown in FIG. 5;

FIG. 9 is a table showing an example of edge node transfer control information used in the edge node shown in FIG. 5;

FIG. 10 is a table showing an example of backbone transfer control information used in the backbone node shown in FIG. 6;

FIG. 11 is a flow chart showing an operating procedure of the IP-VPN of the present invention;

FIG. 12 is a block diagram showing another exemplary configuration of the edge node and the backbone node used in the IP-VPN of the present invention;

FIG. 13 is a block diagram showing another exemplary configuration of the in-network packet transmitted and received in the backbone network shown in FIG. 1 in an IP security scheme;

FIG. 14 is a block diagram showing another exemplary configuration of the in-network packet transmitted and received in the backbone network shown in FIG. 1 in an MPLS scheme; and

FIG. 15 is a block diagram showing another exemplary configuration of the in-network packet transmitted and received in the backbone network shown in FIG. 1 in a GMN-CL scheme.

### DETAILED DESCRIPTION OF THE PREFERRED EMBODIMENTS

Next, the present invention is described with reference to the drawings.

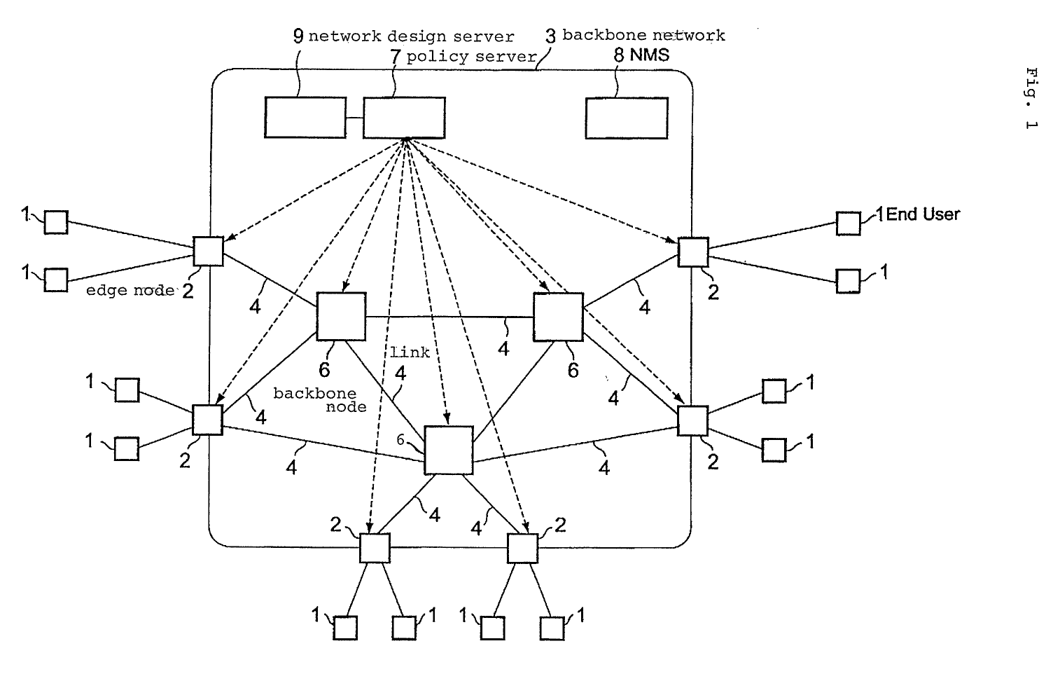

FIG. 1 is a block diagram showing a configuration of a network for realizing an IP-VPN of the present invention.

As shown in FIG. 1, the network for realizing the IP-VPN of the present invention comprises edge nodes 2 for receiving IP data (hereinafter referred to as “user packet(s)”) from transmitting end users 1 to transfer the IP data after predetermined in-network additional information is added thereto to backbone network 3 such as the Internet, and for deleting in-network additional information in packets (hereinafter referred to as “in-network packet(s)”) received from backbone network 3 to transfer the packets to end users 1 of transfer targets as user packets, backbone nodes 6 placed within backbone network 3 for transferring the in-network packets including the in-network additional information added thereto at edge nodes 2, links 4 for connecting edge nodes 4 with backbone nodes 6, policy server 7 for providing edges nodes 2 and backbone nodes 6 with transfer-control information for transfer control of the in-network packets, and network management system (NMS) 8 for monitoring faults in edge nodes 2, backbone nodes 6, and links 4 constituting backbone network 3, respectively. Policy server 7 is connected to network design server 9 for creating the transfer control information of the in-network packets to be supplied to edge nodes 2 and backbone nodes 6.

While FIG. 1 shows a configuration in which six edge nodes 2 and three backbone nodes 6 are provided and two end users (such as servers) 1 are connected to one edge node 2, the numbers of end users 1, edge nodes 2, and backbone nodes 6 are not limited thereto.

Edge node 2 includes an ingress edge node (not shown) for receiving user packets from end users 1 to transfer them to the backbone network, and an egress edge node (not shown) for receiving in-network packets from backbone network 3 to transfer them to end users 1. The ingress edge node and the egress edge node are functionally classified, and one edge node 2 may have both functions or have one of the functions.

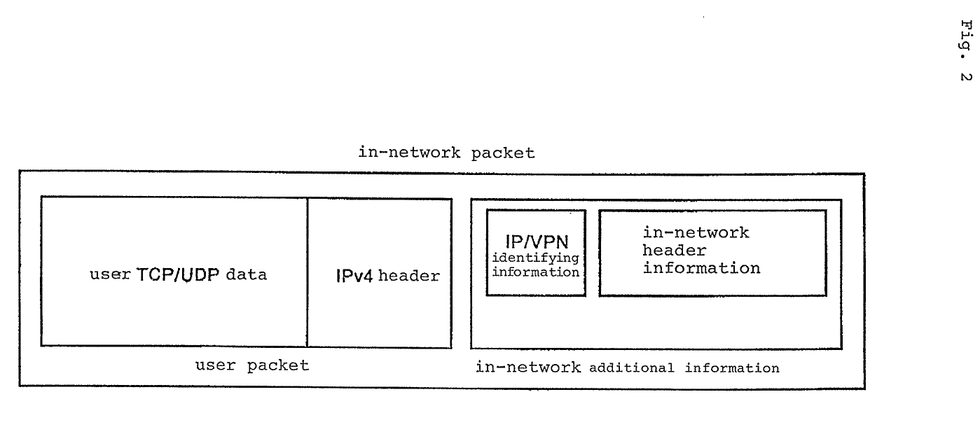

As shown in FIG. 2, an in-network packet transferred within backbone network 3 comprises a user packet including user TCP/UDP data and in-network additional information which is added at the ingress edge node. The in-network additional information is configured, for example, in the same form as an IPv4 header, comprising in-network header information including transfer control information of the in-network packet and IP-VPN identifying information for identifying an IP-VPN.

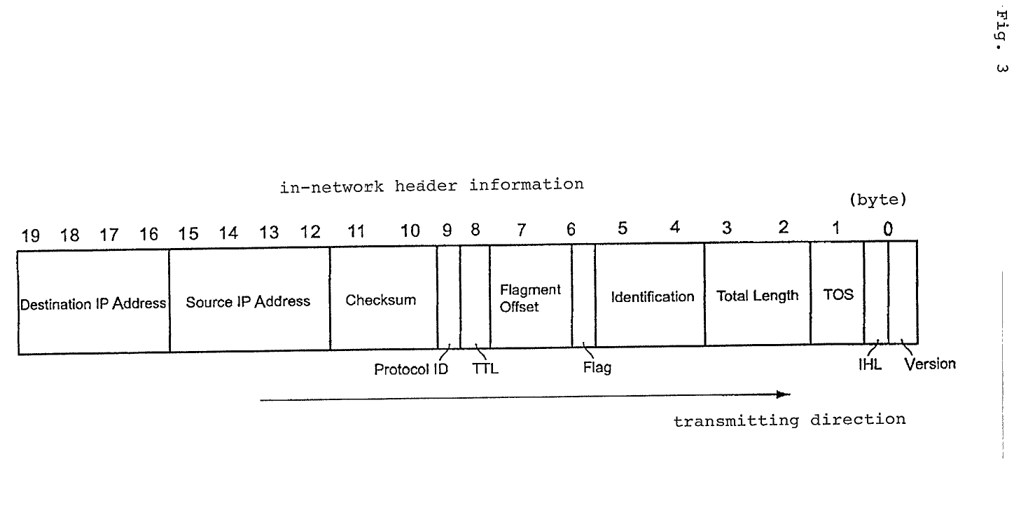

As shown in FIG. 3, in “TOS (Type Of Service) byte” (1 byte) in the in-network header information, a codepoint for Diffserv (Differential Services) corresponding to quality control information of ingress transfer control information, later described, is set. As the codepoint, information defined in RFC2474, for example, is used. The in-network packet is determined in terms of precedence (precedence class) by the codepoint, and transferred with communication quality (such as a bandwidth to be secured) according to the determined priority class.

In “Protocol ID,” any number of “130” to “254” may be set. In “Destination IP Address,” the IP address of the egress edge node to which the in-network packet is to be transferred is inserted. The egress edge node is assigned a plurality of IP addresses according to communication quality levels of in-network packets. Edge nodes 2 and backbone nodes 6 transfer received in-network packets to predetermined transfer targets for which predetermined communication quality can be ensured on the basis of the transfer control information supplied from policy server 7. This means that the transfer route of an in-network packet is uniquely determined by the IP address (hereinafter referred to as “quality control address” in some cases) assigned to the egress edge node.

In “Source IP Address,” the IP address of the ingress edge node itself which adds the in-network additional information to the user packet is inserted. As this IP address, one of the quality control addresses assigned to edge node 2 is used. Since other information are similar to those in the IPv4 header, the description thereof is omitted.

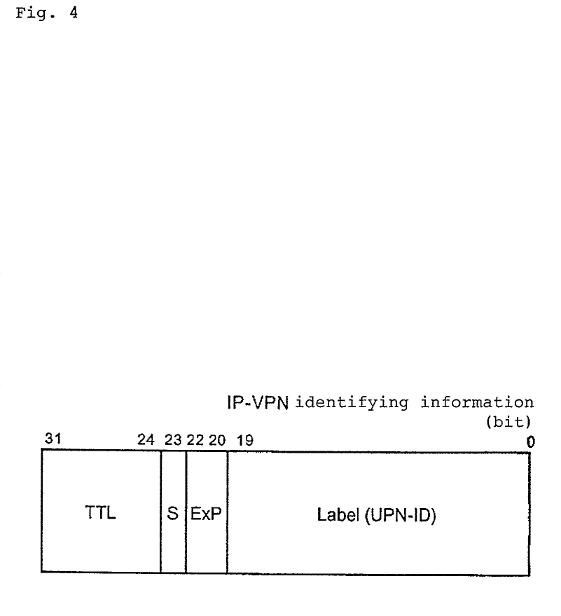

On the other hand, in the IP/VPN identifying information, information in the same form as “Shim Header” defined in the MPLS scheme is inserted. As shown in FIG. 4, the IP-VPN identifying information uses only Label corresponding to the first 20 bits. In this Label, an identifier for identifying a VPN assigned to end user 1 to whom the packet is to be transmitted is inserted. The remaining items of “Ex,” “S,” and “TTL” are unused.

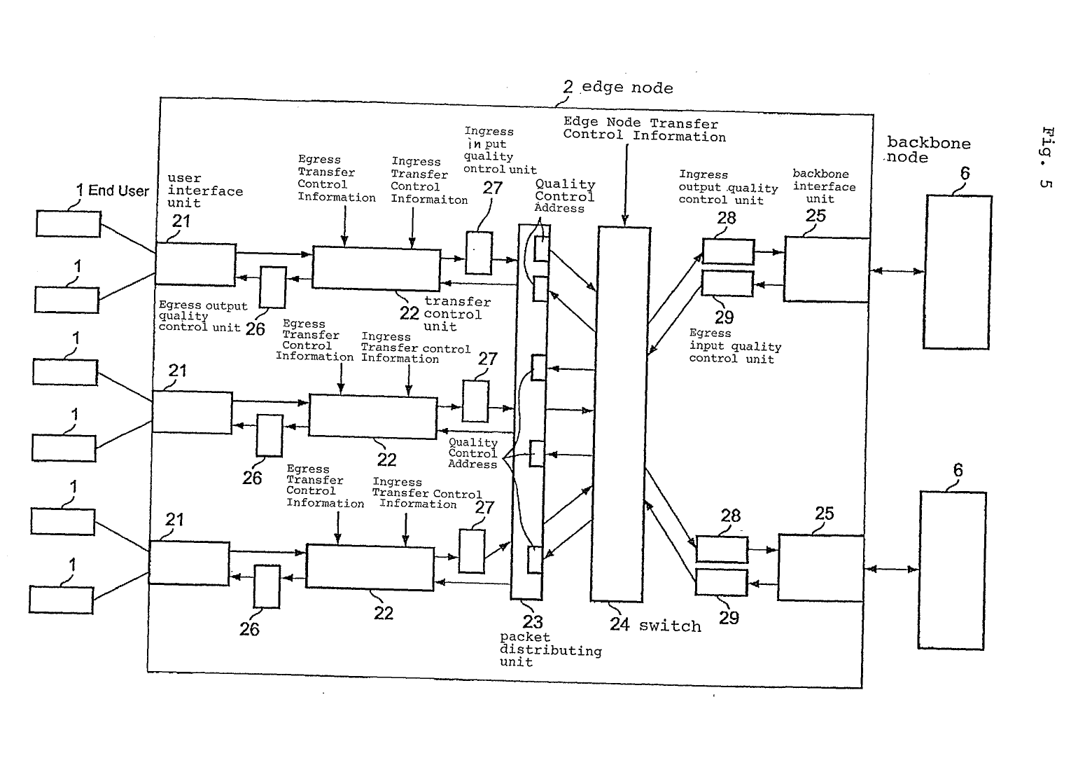

Next, the configuration of edge node 2 is described with reference to FIG. 5.

FIG. 5 is a block diagram showing an exemplary configuration of the edge node shown in FIG. 1.

As described above, the ingress edge node receives a packet from end user 1 to transfer it to backbone network 3 after it adds in-network additional information thereto, while the egress edge node receives an in-network packet from backbone network 3 to transfer it to end user 3 after it deletes in-network additional information therefrom. FIG. 5 shows a configuration for realizing both functions of the ingress edge node and egress edge node.

In FIG. 5, edge node 2 comprises user interface units 21 for transmitting/receiving user packets to and from end users 1, transfer control units 22 for adding/deleting in-network additional information to and from the user packets, ingress input quality control units 27 for limiting the bandwidths (policing function) of the user packets received from end users 1, egress output quality control units 26 for limiting the output bandwidths (shaping function) of user packets for respective end users, switch 24 for switching received in-network packets to predetermined transfer routes, packet distributing unit 23 for unconditionally transferring the in-network packets received from ingress input quality control units 27 to switch 24 and transferring the in-network packets received from switch 24 to predetermined transfer control units 22, ingress output quality control units 28 for receiving the in-network packets from switch 24 and limiting the output bandwidths (shaping function) to backbone network 3 for respective end users of transmission targets, egress input quality control units 29 for limiting the bandwidths (policing function) of in-network packets received from backbone network 3, and backbone interface units 25 for transmitting/receiving in-network packets to and from backbone nodes 6.

As shown in FIG. 5, user interface unit 21, transfer control units 22, ingress input quality control unit 27, and egress output quality control unit 26 are provided for a predetermined number (two in FIG. 5) of end users 1, and ingress output quality control unit 28, egress input quality control unit 29, and backbone interface unit 25 are provided for each backbone node 6.

Packet distributing unit 23 is provided with a plurality of quality control addresses (Addresses) which are the IP addresses of the egress edge node assigned in accordance with the communication quality levels of in-network packets. Switch 24 transfers an in-network packet received from egress input quality control unit 29 to the output port assigned the quality control address of distributing unit 23 matching “Destination IP Address” in the in-network additional information. Packet distributing unit 23 transfers the in-network packet received from switch 24 to transfer control unit 22 associated with end user 1 of the transmission target on the basis of the IP-VPN identifying information in the in-network additional information.

Switch 24 determines backbone node 6 of the transfer target from “Destination IP Address” in the in-network additional information of an in-network packet received from packet distributing unit 23, and transfers the in-network packet to ingress output quality control unit 28 associated with that backbone node 6. The transfer target of an in-network packet is determined using edge node transfer control information, later described.

Transfer control unit 22 determines in-network additional information from address information in a user packet received from end user 1, produces an in-network packet including the in-network additional information, and transfers the packet after it determines the transfer target. In addition, transfer control unit 22 has a function for deleting the in-network additional information in an in-network packet received from backbone node 6 to produce a user packet and for transferring the packet to end user 1 after it determines the transfer target.

Ingress transfer control information, later described, is used in the processing of adding in-network additional information to a user packet and transferring it, while egress transfer control information, later described, is used in the processing of deleting in-network additional information form an in-network packet and determining its transmission target. Transfer control unit 22 is provided for each IP-VPN to which end user 1 belongs, and performs transfer control only for user packets to and from end user 1 who belongs to a predetermined IP-VPN.

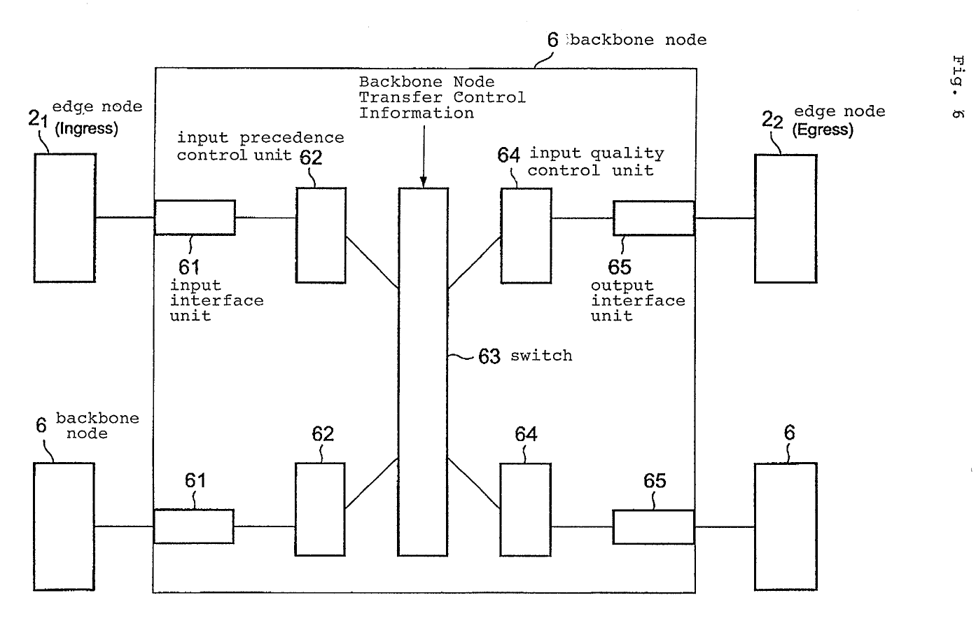

Subsequently, the configuration of backbone node 6 is described with reference to FIG. 6.

FIG. 6 is a block diagram showing an exemplary configuration of the backbone node shown in FIG. 1.

In FIG. 6, backbone node 6 comprises input interface units 61 for receiving in-network packets from ingress edge node (Ingress) 2₁ or adjacent backbone node 6, output interface units 65 for transmitting in-network packets to egress edge node 2₂ or adjacent backbone node 6, switch 63 for transferring received in-network packets to predetermined transfer targets, input precedence control units 62 for checking the value of the TOS byte in the added in-network header information in a received in-network packet and transmitting packets to switch 63 in order of precedence class defined by Diffserv, and output quality control units 64 for checking the value of the TOS byte in the in-network header information in a received in-network packet and transferring packets to output interface units 65 in order of precedence class defined by Diffserv.

As shown in FIG. 6, input interface unit 61 and input precedence control unit 62 are provided for each of ingress edge node 2₁ and adjacent backbone node 6 from which in-network packets are transferred. Output interface unit 65 and output quality control unit 64 are provided for each of egress edge node 2₂ and adjacent backbone node 6 to which in-network packets are transferred.

Switch 63 checks the value of “Destination IP Address” of the in-network header information of a received in-network packet, determines its transfer target based on backbone node transfer control information, later described, and transfers the received in-network packet to the transfer target.

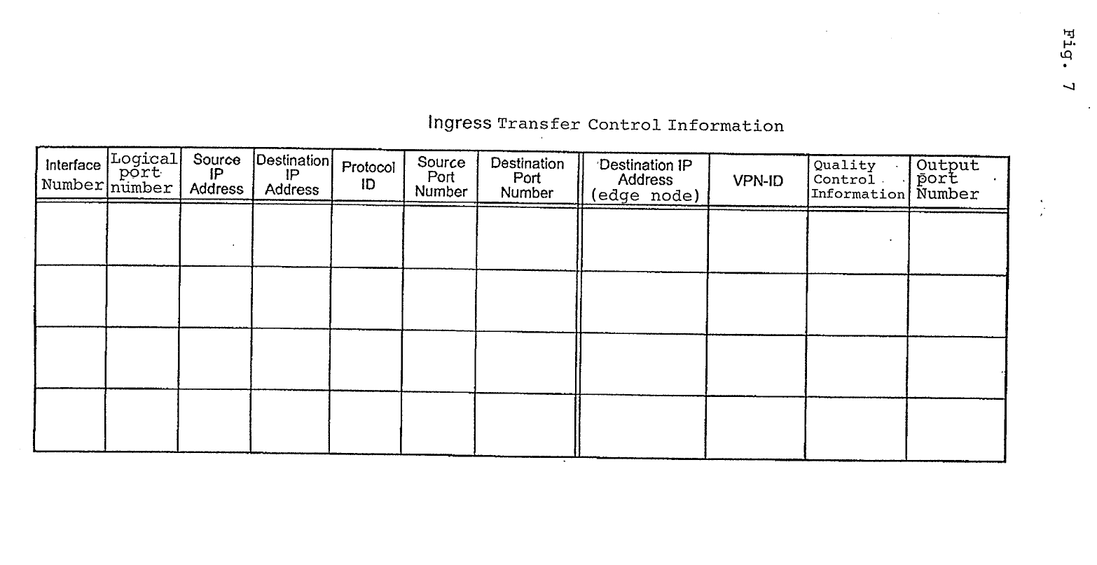

Next, description is made for the ingress transfer control information, the egress transfer control information, and edge node transfer control information for use in edge node 2, and the backbone node transfer control information for use in backbone node 6, with reference to FIG. 7 to FIG. 10.

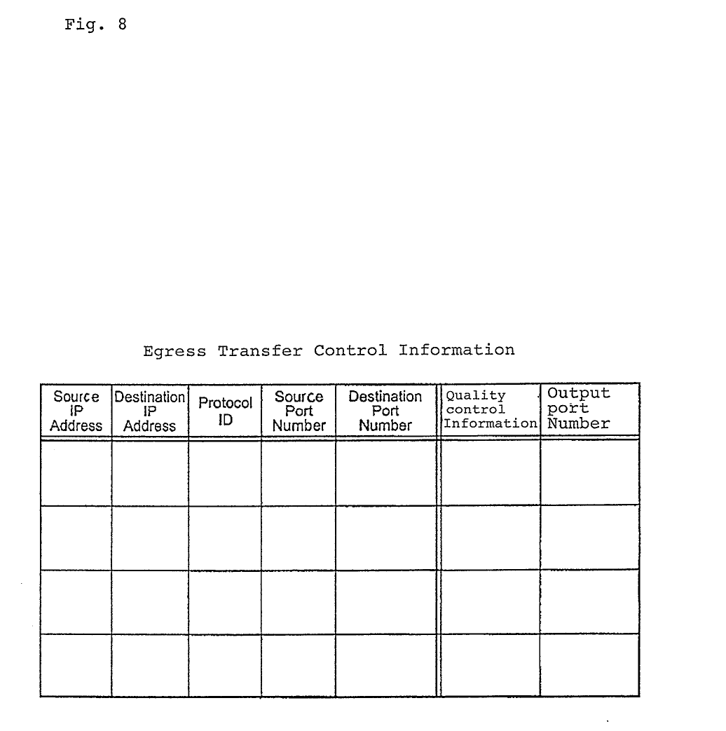

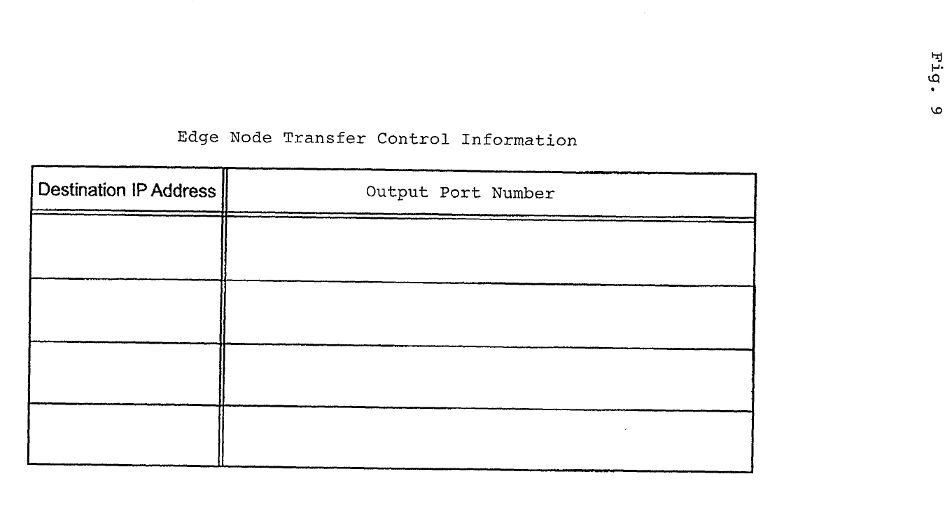

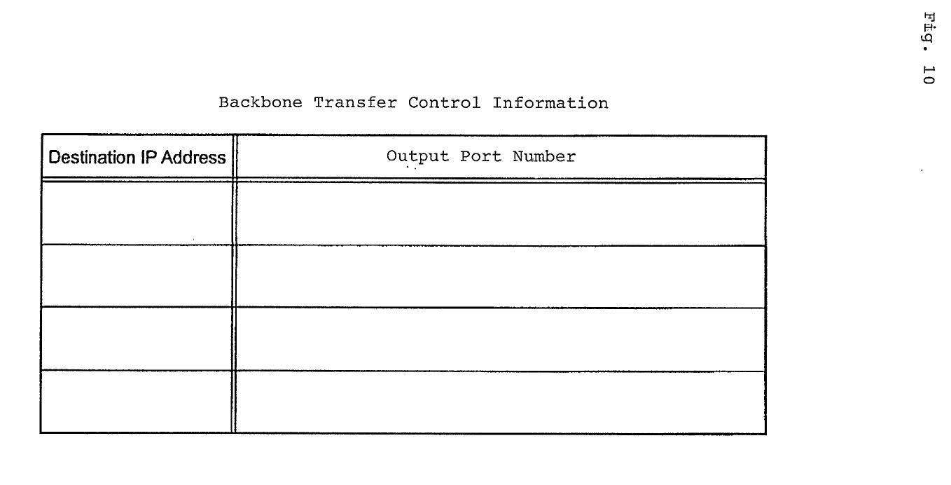

FIG. 7 is a table showing an example of the ingress transfer control information for use in the edge node shown in FIG. 5, while FIG. 8 is a table showing an example of the egress transfer control information for use in the edge node shown in FIG. 5. FIG. 9 is a table showing an example of the edge node transfer control information for use in the edge node shown in FIG. 5, while FIG. 10 is a table showing an example of the backbone transfer control information for use in the backbone node shown in FIG. 6.

The ingress transfer control information is provided from policy server 7 for each edge node and is used in each edge node transfer control unit 22, ingress input quality control unit 27, and ingress output quality control unit 28. The ingress transfer control information is used in determining in-network additional information associated with various information inserted into the IPv4 header in a user packet.

Specifically, as shown in FIG. 7, the ingress transfer control information comprises “Destination IP Address” which is the IP address of a transmission target, “VPN-ID” which is an identifier for identifying a VPN, “quality control information,” and “output port number,” defined for each of the entries of “Source IP Address,” “Destination IP Address,” “Protocol ID,” “Source Port Number,” and “Destination Port Number,” which are present in the IP header of a user packet, “Interface number” which is the number of input interface unit 61 receiving the packet from an end user, and “logical port number” when that input interface unit 61 comprises a plurality of logical ports. “Quality control information” provided as part of the ingress transfer control information includes codepoint information for Diffserv set in the TOS byte of in-network header information, information on the limit of the input bandwidth policed in ingress input quality control unit 27 of edge node 2, and information on the limit of the output bandwidth shaped in ingress output quality control unit 28. “Output port number” is an output interface number and a logical port number defined in an edge node.

On the other hand, the egress transfer control information is provided from policy server 7 for each edge node, and is used in edge node transfer control unit 22, egress input quality control unit 29, and egress output quality control unit 26. The egress transfer control information is used for transfer control of a packet to an end user associated with various information inserted into the IPv4 header in a user packet.

Specifically, as shown in FIG. 8, the egress transfer control information comprises “quality control information” and “output port number” defined for each of the entries of “Source IP Address,” “Destination IP Address,” “Protocol ID,” “Source Port Number,” and “Destination Port Number,” which are present in the IP header of a user packet from end user 1. “Quality control information” provided as part of the egress transfer control information includes information on the limit of the input bandwidth policed in egress input quality control unit 29 of edge node 2, and information on the limit of the output bandwidth shaped in egress output quality control unit 26. “Output port number” is an output interface number and a logical port number defined in an edge node.

The edge node transfer control information is provided from policy server 7 for each edge node and is used in switch 24 for determining the transfer target of an in-network packet. As shown in FIG. 9, the edge node transfer control information includes “output port number” which is information defined corresponding to the entry including “Destination IP Address” present in the in-network header information of in-network additional information for determining an output port in edge node 2. “Output port number” in this case is an output interface number and a logical port number defined in edge node 2.

The backbone transfer control information is transmitted from policy server 7 to each backbone node 6 and is used in switch 63 for determining the transfer target of an in-network packet. As shown in FIG. 10, the backbone transfer control information includes “output port number” which is information defined corresponding to the entry including “Destination IP Address” present in the in-network header information of in-network additional information for determining an output port in backbone node 6. “Output port number” in this case is an output interface number and a logical port number defined in backbone node 6.

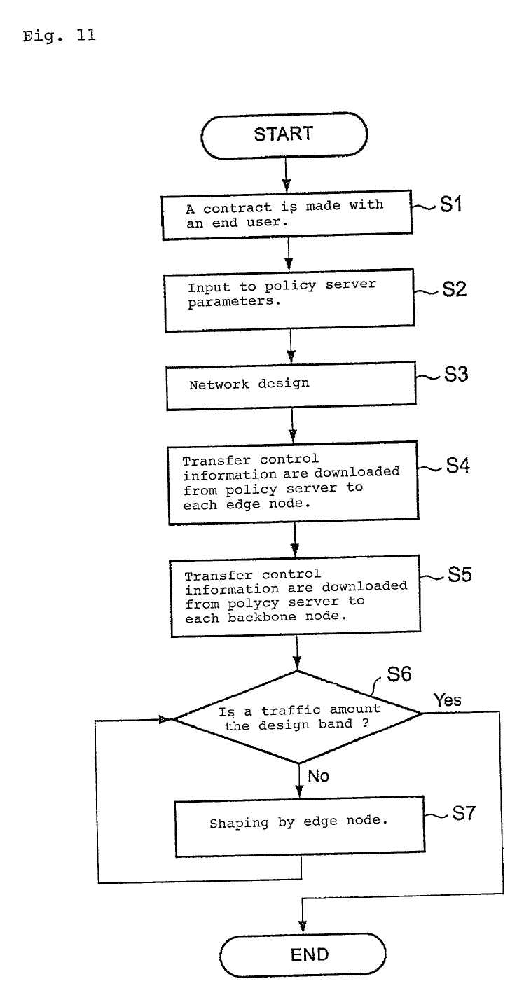

Next, description is made for an operation procedure of the IP-VPN of the present invention with reference to FIG. 11.

FIG. 11 is a flow chart showing the operation procedure of the IP-VPN of the present invention.

In FIG. 11, before IP-VPN services are started, a contract for the IP-VPN services is first made with end user 1 (step S1). Then, an network designer inputs to policy server 7 parameters such as a communication bandwidth requested by end user 1, a class for realizing it, and an IP address (Global Address, Private Address) possessed by end user 1 (step S2).

Policy server 7 performs transfer route design (network design) for securing a required bandwidth based on the input information to set IP addresses for edge node 2 according to communication quality levels, and a VPN-ID which is an identifier for identifying the associated IP-VPN (step S3). The processing of steps S2 and S3 are performed off-line.

After the completion of the network design, the egress transfer control information, the ingress transfer control information, and the edge node transfer control information are downloaded on-line from policy server 7 to each edge node 2 based on the design information (step S4). The backbone node transfer information is downloaded on-line to each backbone node 6 (step S5).

As described above, since a plurality of IP addresses can be assigned to the egress edge node as “Destination IP Address” in in-network header information, policy server 7 assigns a plurality of different “Destination IP Addresses” to one egress edge node in accordance with bandwidths provided for respective end users based on the contract such that in-network packets are routed on the basis of the IP addresses to limit bandwidths for respective users. Specifically, the output port number corresponding to the entry including “Destination IP Address” is defined as part of the edge node transfer control information and the backbone node transfer control information provided for edge node 2 and backbone node 6, thereby determining a stable transfer route.

When the IP-VPN services for the end user under the contract are started, policy server 7 monitors a traffic amount on each transfer route to check whether the bandwidth (communication quality) to be provided for end user 1 under the contract is secured, or whether an in-network packet exceeding the bandwidth under the contract is transferred to backbone network 3 (step S6). When an in-network packet different from the bandwidth to be provided for end user 1 under the contract is transferred to backbone network 3, the shaping function of edge node 2 is used to adjust the output bandwidth of that in-network packet or another in-network packet in a different class (step S7). Then, the procedure returns to the processing at step S6 for again monitoring a traffic amount to maintain the design bandwidth.

Next, description is made for a procedure of transferring a user packet transmitted from end user 1.

A user packet transmitted from end user 1 to ingress edge node 2₁ is input to transfer control unit 22 through user interface unit 21.

Transfer control unit 22 refers to ingress transfer control information and determines in-network additional information from the content of the IPv4 header in the received user packet. Items to be determined as the in-network additional information at this point are “Destination IP Address” and a TOS byte in in-network header information, and a VPN-ID in IP-VPN identifying information. The in-network additional information including the information is added to the user packet to produce an in-network packet which is transferred to ingress input quality control unit 27.

Ingress input quality control unit 27 acquires bandwidth information from “quality control information” in the ingress transfer control information to limit the input bandwidth of the in-network packet. At this point, an in-network packet exceeding a predetermined bandwidth is discarded.

The in-network packet through ingress input quality control unit 27 is transferred to switch 24 through packet distributing unit 23, and transferred to ingress output quality control unit 28 associated with backbone node 6 to which the packet is to be transferred on the basis of “Destination IP Address” in the in-network header information and edge node transfer control information.

Ingress output quality control unit 28 acquires bandwidth information from “quality control information” in the ingress transfer control information to limit the output bandwidth of the in-network packet. With this processing, control is performed to prevent an in-network packet exceeding the bandwidth provided for end user 1 under the contract from being transferred to backbone network 3. Thus, since bandwidths associated with a plurality of QoS (Quality of Service) routes for which bandwidth design is previously performed are secured, the bandwidths of backbone network 3 are properly maintained.

The in-network packet through ingress output quality control unit 28 is transferred to backbone network 3 through backbone interface unit 25, and then transferred to backbone node 6.

Backbone node 6 which receives the in-network packet performs reception processing with input interface unit 61, and transfers the received in-network packet to input precedence control unit 62.

Input precedence control unit 62 checks the value of the TOS byte in the in-network header information of the received in-network packet, holds the value of the TOS byte, i.e. holds the in-network packet for each precedence class corresponding to the codepoint value for Diffserv, and transfers in-network packets to switch 63 in order of precedence class.

Switch 63 of backbone node 6 transfers the in-network packet, based on backbone node transfer control information previously provided from policy server 7 and the value of “Destination IP Address” in the in-network header information, to output quality control unit 64 through the associated output port.

Output transfer control unit 64 checks the value of the TOS byte in the in-network header information of the received in-network packet similarly to input precedence control unit 62, holds the in-network packet for each precedence class corresponding to the codepoint value of Diffserv, and transfers in-network packets to output interface unit 65 in order of precedence class.

In this manner, backbone node 6 transfers in-network packets in order of precedence class to thereby secure a communication bandwidth for each class.

Output interface unit 65 transfers the in-network packet to another backbone node 6 or egress edge node 2₁ which is the transfer target. An in-network packet transferred to another backbone node 6 is subjected to processing similar to the aforementioned processing.

An in-network packet transferred to the egress edge node is received at backbone interface unit 25 and transferred to egress input quality control unit 29.

Egress input quality control unit 29 acquires bandwidth information from “quality control information” of egress transfer control information to limit the input bandwidth. At this point, egress input quality control unit 29 does not delete in-network additional information of the in-network packet but finds the associated entry in the egress transfer control information based on the information of the IPv4 header of the user packet in the in-network packet, and performs the processing according to the associated bandwidth information.

The in-network packet through egress input quality control unit 29 is transferred to switch 24, and is transferred to the output port of packet distributing unit 23 corresponding to “Destination IP Address” in the in-network header information based on the edge node transfer control information.

Packet distributing unit 23 determines transfer control unit 22 to which the packet is to be transferred on the basis of the VPN-ID in IP-VPN identifying information and transfers the packet to that transfer control unit 22.

Transfer control unit 22 which receives the in-network packet deletes the in-network additional information and checks whether the VPN-ID and the information of the IPv4 header of the user packet match the entries in the egress transfer control information, and if they match, determines the output port for transfer to the associated egress output quality control unit 26. However, even when the information of the IPv4 header of the user packet matches the entry in the egress transfer control information, the in-network packet is discarded if the VPN-ID does not match that of the IP-VPN identifying information of the in-network additional information.

This maintains the closed nature for each VPN-ID, and packets can be transferred even when the same private address as “Destination IP Address” or “Source IP Address” of a user packet is used in each IP-VPN.

Egress output quality control unit 26 acquires bandwidth information which is part of the quality control information in the egress transfer control information to limit the output bandwidth. Finally, only the user packet is transferred to end user 1 through user interface unit 21.

As described above, the user packet is transferred to backbone network 3 after the in-network additional information is added thereto, and the egress edge node is assigned a plurality of different IP addresses according to communication quality levels, thereby making it possible to construct an IP-VPN on a QoS basis capable of securing a required bandwidth for each end user.

Even when an IP-VPN network on an MPLS basis is connected to an IP-VPN network to realize interconnection (internetworking) of the IP-VPNs, interconnection can be achieved with relative ease only by converting the aforementioned in-network header information into a MPLS label.

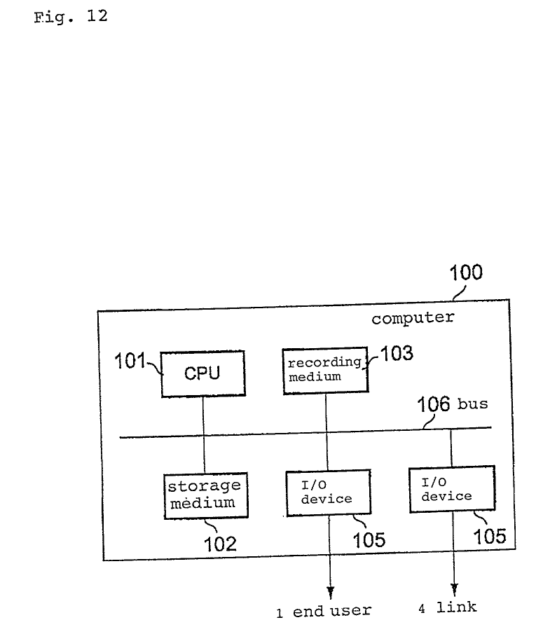

While the aforementioned description shows a case where each of edge nodes 2 and backbone nodes 6 is formed of a plurality of units corresponding to respective functions, edge node 2 and backbone node 6 may be formed of computer 100 as shown in FIG. 12. FIG. 12 is a block diagram showing another exemplary configuration of the edge node and the backbone none node for use in the IP-VPN of the present invention.

As shown in FIG. 12, computer 100 comprises CPU 101, storage device 102 for storing various data required for the processing of CPU 101, recording medium 103 for recording transfer control programs for causing CPU 101 to perform transfer control processing of in-network packets, and a plurality of I/O devices 105 connected to end user 1 or link 4 and serving as interfaces for transmitting and receiving packets. CPU 101, storage device 102, recording medium 103, and I/O devices 105 are connected to one another through bus 106.

CPU 101 reads the transfer control programs recorded in recording medium 103 and performs processing similar to the aforementioned transfer control processing of in-network packets in edge node 2 or backbone node 6 in accordance with the read transfer control programs. Recording medium 103 may be a magnetic disk, an optical disk, a semiconductor memory and another recording device. Such a configuration can provide effects similar to the aforementioned effects.

As schemes for realizing the current IP-VPN services, an IP security scheme, an MPLS scheme, and a GMN-CL scheme are known. The virtual private network of the present invention differs from those in the following points.

1. IP security scheme

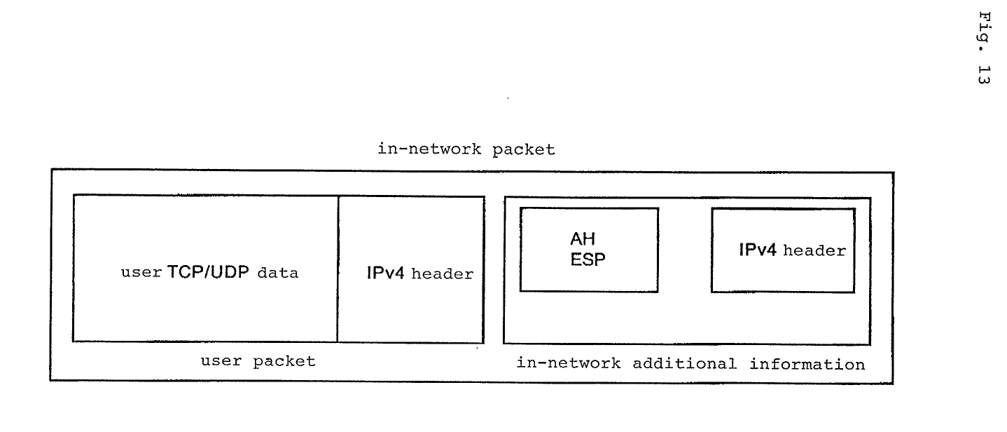

In the IP security scheme, in-network additional information as shown in FIG. 13 is added in front of a user packet. As shown in FIG. 13, in the IP security scheme, an AH (Authentication Header) or an ESP (Encapsulating Security Payload) is inserted into the portion where IP-VPN identifying information is inserted in the present invention.

2. MPLS scheme

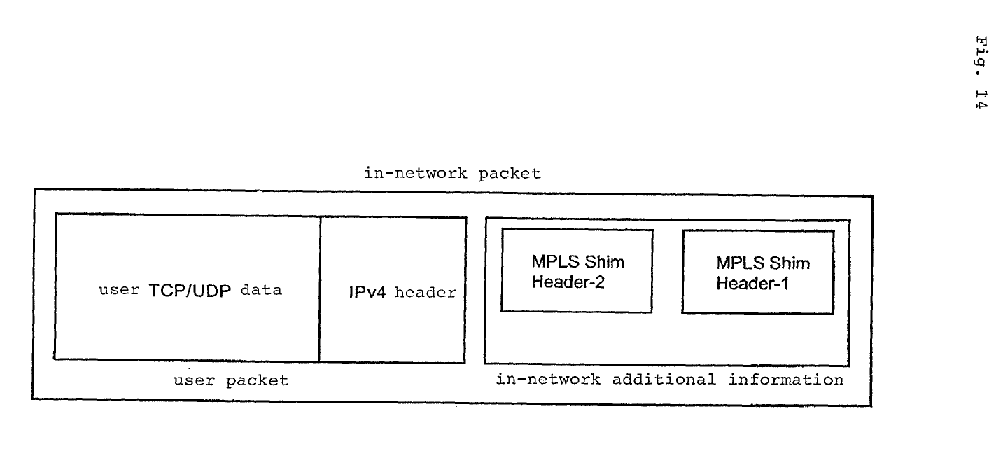

In the MPLS scheme, as shown in FIG. 14, a number of MPLS shim headers are added to a user packet corresponding to the levels of a network.

3. GMN-CL scheme

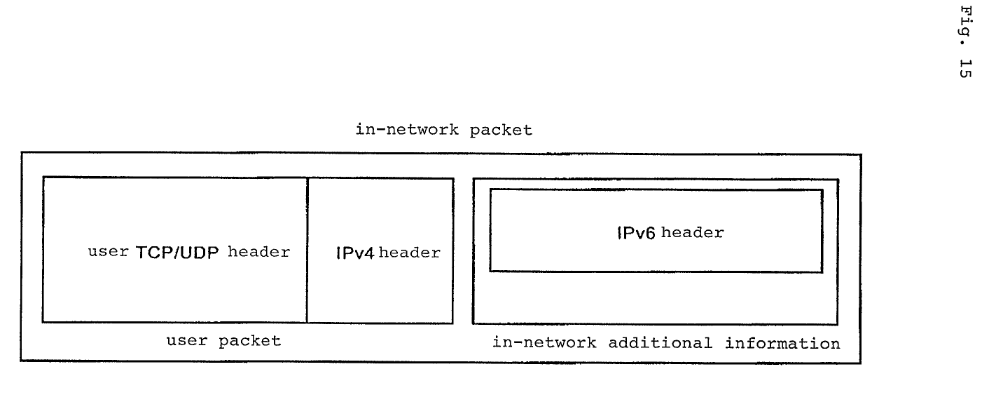

In the GMN-CL scheme, as shown in FIG. 15, a header in IPv6 format is added to a user packet.

Since the present invention is configured as described above, the effects as described below are presented.

A user packet from an end user is transferred to the backbone network after in-network additional information is added thereto, and an edge node connecting to a transfer target user is assigned a plurality of different IP addresses in accordance with precedence. Thus, a stable transfer route for securing a required bandwidth is determined to make it possible to construct an IP-VPN capable of securing a bandwidth based on the contract with the user.

In addition, the edge node limits the output bandwidth of an in-network packet according to predetermined quality control information to perform control such that an in-network packet exceeding the bandwidth based on the contract with a user is not transmitted to the backbone network. Thus, since bandwidths associated with a plurality of QoS routes for which bandwidth design is previously performed are secured, the bandwidths of the backbone network are properly maintained.

Also, even when an IP-VPN network on an MPLS basis is connected to an IP-VPN network to realize interconnection of the IP-VPNs, interconnection can be achieved with relative ease only by converting in-network header information into a MPLS label.

Furthermore, since the precedence control unit included in the backbone node transfers in-network packets in order of precedence class, a communication bandwidth for each class can be ensured.

What is claimed is:

1. A method of constructing an IP virtual private network comprising a virtual dedicated line for performing communication between particular users on a backbone network, comprising the steps of:
creating an in-network packet by adding, to a user packet including IP data transmitted from a user, in-network additional information comprising in-network header information in the same form as an IPv4 format including information identifying a user to whom the user packet is to be transmitted and representing precedence of the user packet and IP-VPN identifying information in the same form as a shim header of an MPLS scheme including a VPN-ID serving as an identifier for identifying each of a plurality of virtual private networks present within said backbone network, and transmitting the created in-network packet to said backbone network; and
deleting said in-network additional information from said in-network packet transmitted from said backbone network, and transferring the packet to a predetermined user as said user packet.

2. The method of constructing an IP virtual private network according to claim 1, wherein an edge node possessed by said backbone network and connected to said user is assigned a plurality of different IP addresses in accordance with said precedence for securing a communication bandwidth required by said user, and
an IP address for transferring said in-network packet to said edge node connected to the user to whom the packet is to be transmitted on a route in accordance with said precedence is inserted in said in-network header information.

3. An IP virtual private network comprising a virtual dedicated line for performing communication between particular users constructed on a backbone network, comprising:
a plurality of edge nodes for creating an in-network packet by adding, to a user packet including IP data transmitted from said user, in-network additional information comprising in-network header information in the same form as an IPv4 format including information identifying a user to whom the user packet is to be transmitted and representing precedence of the user packet and IP-VPN identifying information in the same form as a shim header of an MPLS scheme including a VPN-ID serving as an identifier for identifying each of a plurality of virtual private networks present within said backbone network, and
a plurality of backbone nodes for transferring said in-network packet to said edge node connected to the user to whom the packet is to be transmitted.

4. The IP virtual private network according to claim 3, wherein said edge node deletes said in-network additional information from said in-network packet transmitted from said backbone network and transfers the packet to a predetermined user as said user packet.

5. The IP virtual private network according to claim 3, wherein said edge node is supplied with transfer control information for determining a transfer target of said in-network packet, bandwidth information in accordance with said precedence, and contents of said in-network additional information, and
the IP virtual private network further comprising a policy server for providing said backbone node with backbone transfer control information for indicating a transfer target of said in-network packet.

6. The IP virtual private network according to claim 5, wherein said edge node limits a bandwidth of an in-network packet to be output in accordance with said bandwidth information.

7. The IP virtual private network according to claim 3, wherein said edge node is assigned a plurality of different IP addresses in accordance with said precedence for securing a communication bandwidth required by said user, and
the edge node connected to the user from which the packet is transmitted inserts in said in-network header information an IP address for transferring said in-network packet to the edge node connected to the user to whom the packet is to be transmitted on a route in accordance with said precedence.

8. An edge node provided on a backbone network and connected to a user for constructing an IP virtual private network comprising a virtual dedicated line for performing communication between particular users on said backbone network, comprising:
a transfer control unit for creating an in-network packet by adding, to a user packet including IP data transmitted from said user, in-network additional information comprising in-network header information in the same form as an IPv4 format including information identifying a user to whom the user packet is to be transmitted and representing precedence of the user packet and IP-VPN identifying information in the same form as a shim header of an MPLS scheme including a VPN-ID serving as an identifier for identifying each of a plurality of virtual private networks present within said backbone network; and
a switch for switching transfer routes of said in-network packet.

9. The edge node according to claim 8, wherein said transfer control unit deletes said in-network additional information from said in-network packet transmitted from said backbone network.

10. The edge node according to claim 8, further comprising a packet distributing unit assigned a plurality of different IP addresses in accordance with the precedence for securing a communication bandwidth required by said user.

11. The edge node according to claim 8, further comprising a quality control unit for limiting a bandwidth of an in-network packet to be output in accordance with predetermined bandwidth information.

12. A backbone node provided for constructing an IP virtual private network comprising a virtual dedicated line for performing communication between particular users on a backbone network, comprising:
a switch for switching transfer routes of a received packet in accordance with predetermined transfer control information; and
a precedence control unit for transferring packets in order of precedence set in accordance with a communication bandwidth required by said user.

13. A policy server provided for constructing an IP virtual private network comprising a virtual dedicated line for performing communication between particular users on a backbone network, comprising:
edge node information supply means for supplying an edge node provided on said backbone network and connected to said user with transfer control information for determining contents of in-network additional information comprising in-network header information in the same form as an IPv4 format including a transfer target of a packet, bandwidth information in accordance with precedence set for said packet, and information identifying a user to whom the packet is to be transmitted and representing precedence of a user packet, and IP-VPN identifying information in the same form as a shim header of an MPLS scheme including a VPN-ID serving as an identifier for identifying each of a plurality of virtual private networks present within said backbone network; and
backbone node information supply means for supplying a backbone node provided on said backbone network with backbone transfer control information for indicating a transfer target of a packet.
